(19) United States
(12) Patent Application Publication
(10) Pub. No.: US 2004/0083777 A1
(43) Pub. Date: May 6, 2004

(54) Tamper resistant lock assembly

(76) Inventor: Robert A. Vito, Berwyn, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/286,327

(22) Filed: Nov. 2, 2002

(51) Int. Cl. E05B 67/36

(52) U.S. Cl. 70/32; 70/34

(57) ABSTRACT

A lock assembly adapted to engage a closure eye. A piston is slideably positioned in the housing for movement between a first piston position, in which the piston is substantially positioned inside the housing, and a second piston position, in which a portion of the piston extends from the housing. A bolt is moveable from a first bolt position into a second bolt position. When the bolt is substantially in the second bolt position and the piston is moved into the first piston position, the bolt moves into a third bolt position, in which the bolt is substantially within the housing. The bolt is adapted to be positioned within the closure eye at least while in the third bolt position.

### BACKGROUND

The present invention is related to lock assemblies and, more specifically, to a lock assembly adapted to engage a closure eye while simultaneously protecting the closure eye and the portion of a bolt extending therethrough.

Hasps are typically for locking two elements together. Typically the two elements consist of a moveable element which is to be held in a fixed position relative to a second element, which may be fixed or moveable, in order to prevent the opening of the moveable element. The common hasp has two parts. The first part is generally comprised of a hasp eye, or closure eye, which is connected to one of the two elements. The second part is hasp faceplate which is connected to the other of the two elements. The hasp faceplate typically includes a slot for receiving the closure eye. The faceplate may be fixed directly to the other of the two elements or it may be connected to a mounting plate which is in turn connected to the other of the two elements so that the faceplate can be pivoted into and out of position over the closure eye without moving the moveable element relative to the second element. Typical uses for hasp assemblies are for locking a door, a cupboard, a gate, a locker, or the like in a closed position.

Typically a padlock or other type of lock is inserted through the closure eye in order to lock the faceplate in position. However, the closure eye is typically exposed and an unauthorized person can use a pair bolt cutters to simply snip the closure eye. It is also possible for an unauthorized user to attempt to cut the shank of the lock if it is exposed.

Clearly what is needed is a lock assembly capable of securing a faceplate over a closure eye or locking onto a similar closure eye incorporating security device, that also protects the closure eye and the portion of the bolt extending therethrough, and that preferably also protects a portion of the hasp faceplate or other closure eye supporting structure.

### SUMMARY

One embodiment of the present invention is directed to a lock assembly adapted to engage a closure eye. The lock assembly includes a housing having a mating surface. The mating surface defines a recess therein. The recess is adapted to receive the closure eye. A piston is slideably positioned in the housing for movement between a first piston position, in which the piston is substantially positioned inside the housing, and a second piston position, in which a portion of the piston extends from the housing. The piston has a piston end. A bolt is rotatably moveable about the piston end while the piston is in the second piston position for movement from a first bolt position, in which the bolt is located outside of the housing, through the recess into a second bolt position, in which at least a portion of the bolt is inside the housing. When the bolt is substantially in the second bolt position and the piston is moved into the first piston position, the bolt moves into a third bolt position, in which the bolt is substantially within the housing. The bolt is adapted to be positioned within the closure eye at least while in the third bolt position to secure the lock assembly to the closure eye. A locking mechanism is adapted to detachably secure the lock assembly to the closure eye.

A separate embodiment of the present invention is directed to a lock assembly adapted to engage a closure eye. The lock assembly includes a housing having a mating surface. The mating surface defines a recess therein. The recess is adapted to the receive the closure eye. A bolt is rotatably moveable about the housing and is moveable from a first bolt position, in which the bolt is located outside of the housing, through the recess into a second bolt position, in which a least a portion of the bolt is inside the housing. The bolt is adapted to be positioned within the closure eye at least while the bolt is substantially in the second bolt position to secure the lock assembly to the closure eye. A locking mechanism is adapted to detachably secure the lock assembly to the closure eye.

### BRIEF DESCRIPTION OF THE DRAWINGS

The foregoing summary, as well as the following detailed description of the preferred embodiments of the present invention, will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of a first preferred embodiment of the lock assembly of the present invention secured over a closure eye;

FIG. 2 is a second perspective view of the lock assembly of FIG. 1 illustrating a recess in a mating surface of the lock assembly;

FIG. 3 is a perspective view of a second preferred lock assembly according to the present invention illustrating a mating surface having both a recess through which a bolt and a closure eye can pass and having a complementary groove adapted to receive a portion of a hasp faceplate or similar closure eye supporting structure;

FIG. 4 is a perspective view of the lock assembly of FIG. 3 illustrating the bolt in a first bolt position;

FIG. 5 is a perspective view of the lock assembly of FIG. 3 illustrating the bolt in a second bolt position;

FIG. 6 is a perspective view of the lock assembly of FIG. 3 illustrating the placement of the bolt through the closure eye while the bolt is in the first bolt position;

FIG. 7 is a partial cross-sectional view of the lock assembly of FIG. 6 as taken along the line 7-7 of FIG. 6;

FIG. 8 is a perspective view of the lock assembly of FIG. 3 with the bolt inserted through the closure eye and the mating surface of the lock assembly generally covering the closure eye and a portion of the hasp faceplate with the bolt in the second bolt position;

FIG. 9 is a cross-sectional view of the lock assembly of FIG. 8 as taken along the line 9-9 of FIG. 8;

FIG. 10 is a perspective view of the lock assembly of FIG. 8 with the bolt in a third bolt position;

FIG. 11 is a cross-sectional view of the lock assembly of FIG. 10 as taken along the line 11-11 in FIG. 10 illustrating the bolt in the third bolt position with a bolt end secured in a receiving tube and with a double ball bearing dead bolt lock securing the bolt and the piston in position;

FIG. 12 is a third preferred lock assembly according to the present invention illustrating the bolt in the first bolt position;

FIG. 13 is a perspective view of the lock assembly of FIG. 12 illustrating the bolt in the second bolt position;

FIG. 14 is a perspective view of the lock of FIG. 12 illustrating the insertion of the bolt through the closure eye while the bolt is in the first bolt position;

FIG. 15 is a cross-sectional view of the lock assembly of FIG. 14 as taken along the line 15-15 of FIG. 14;

FIG. 16 is perspective view of the lock assembly of FIG. 12 with the bolt positioned through the closure eye and the bolt located in the second bolt position with the mating surface of the lock assembly generally protecting the closure eye, the bolt extending therethrough, and a portion of the hasp faceplate;

FIG. 17 is cross-sectional view of the lock assembly of FIG. 16 as taken along the line 17-17 of FIG. 16;

FIG. 18 is a cross-sectional view of a fourth preferred lock assembly according to the present invention similar to the view of FIG. 17 illustrating an elastic member biasing the bolt toward the first bolt position;

FIG. 19 is a perspective view of a fifth preferred lock assembly according to the present invention illustrating the bolt in the first bolt position;

FIG. 20 is a perspective view of the lock assembly of FIG. 19 illustrating the bolt in the second bolt position;

FIG. 21 is a partially exploded view of the lock assembly of FIG. 19 illustrating the bolt having an angled bolt end and having a crossbar located on a second bolt end;

FIG. 22 is a perspective view of the lock assembly of FIG. 19 illustrating the insertion of the bolt through the closure eye while the bolt in the first bolt position;

FIG. 23 is a cross-sectional view of the lock assembly of FIG. 22 as taken along the line 23-23 of FIG. 22;

FIG. 24 is a perspective view of the lock assembly of FIG. 19 illustrating the bolt inserted through the closure eye with the bolt in the second bolt position and the lock assembly housing covering the closure eye, the bolt extending therethrough, and a portion of the hasp faceplate; and

FIG. 25 is a cross-sectional view of the lock of FIG. 24 as taken along the line 25-25 of FIG. 24; and

FIG. 26 is a cross-sectional view similar to that of FIG. 25 of a sixth preferred lock assembly according to the present invention illustrating the second bolt end curved around a pin.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the lock assembly and designated parts thereof. The word “closure eye”, as used in the claims and in the corresponding portions of this specification, is defined as meaning “a hasp loop, a hasp staple, a hasp eye, a lock receiving loop, or the like.” The words “a” and “one” are defined as including one or more of the referenced item unless specifically stated otherwise. This terminology includes the words above specifically mentioned, derivatives thereof, and words of similar import.

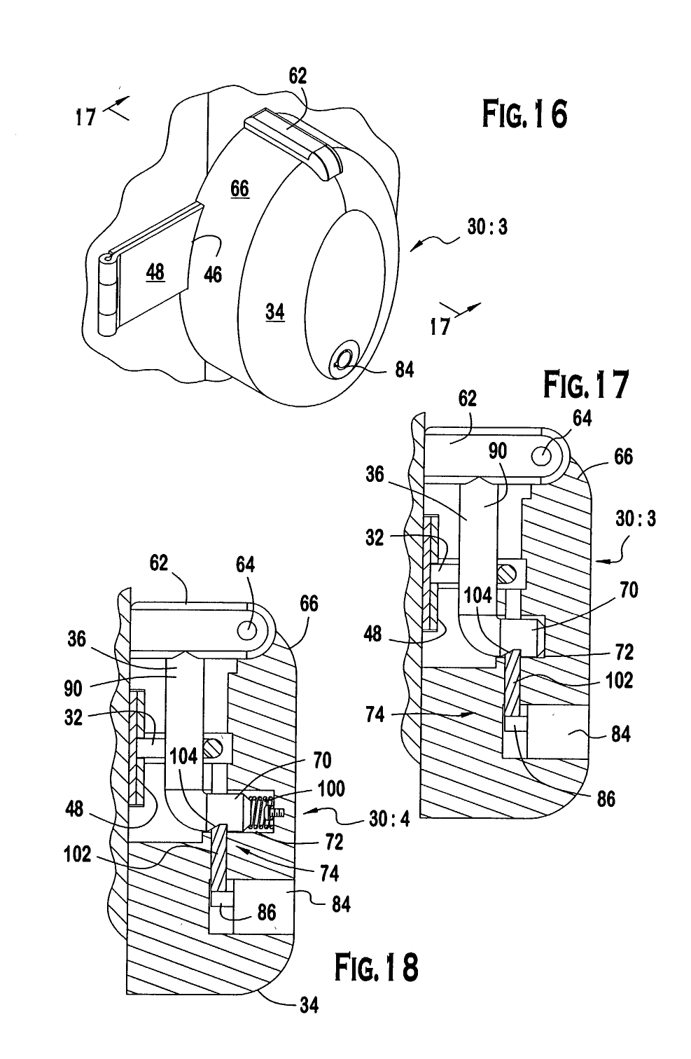

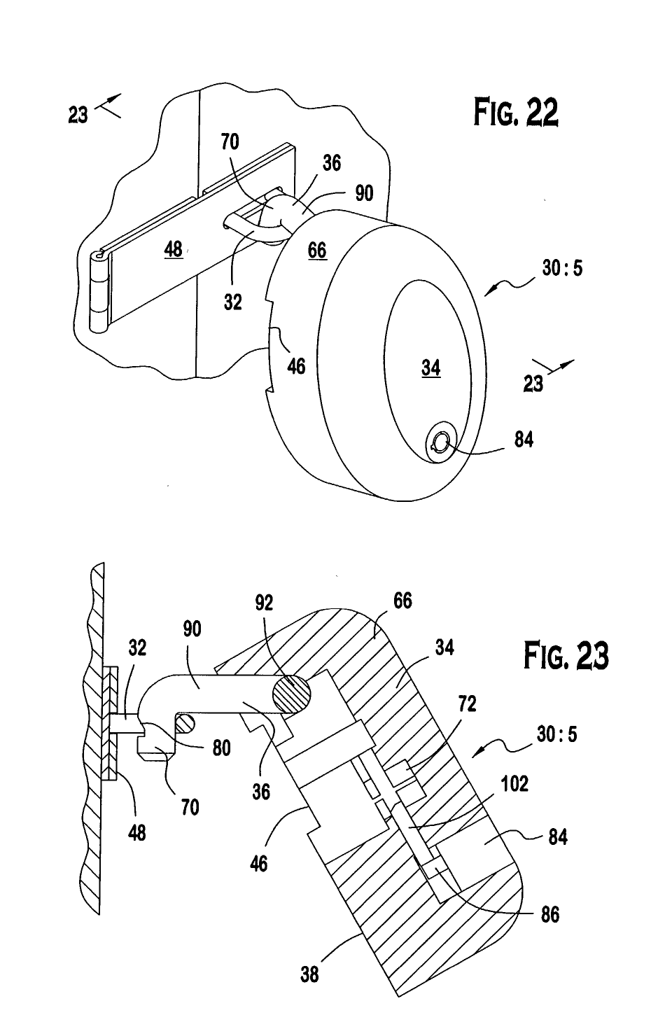

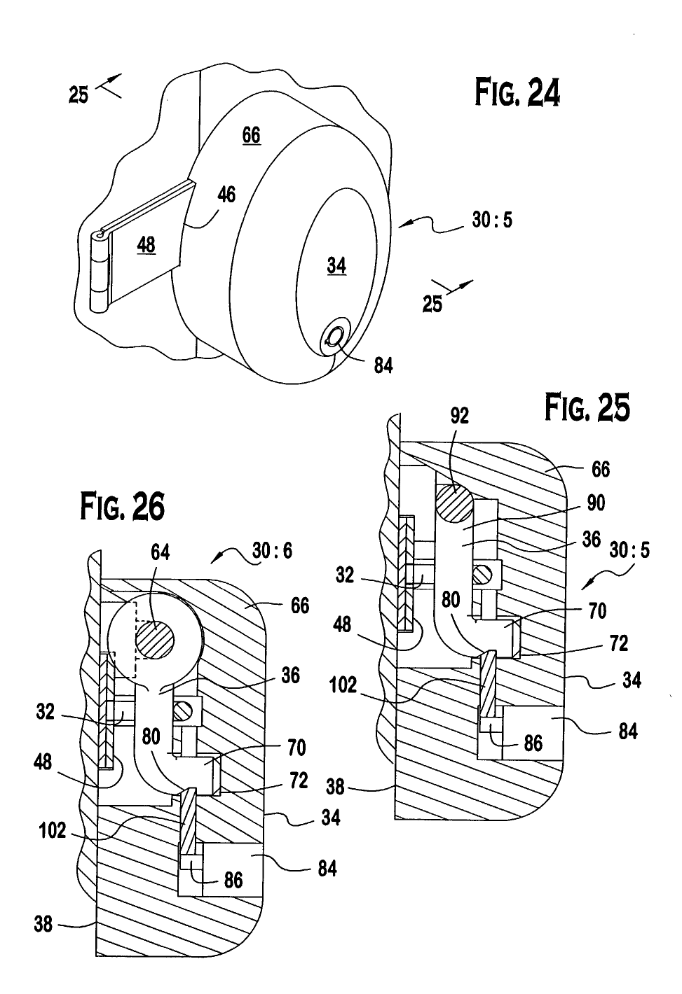

Referring to FIGS. 1-26, wherein like numerals indicate like elements throughout, six preferred embodiments of a lock assembly are shown and designated 30:1-30:6, respectively. Briefly stated, the lock assembly 30:1-30:6 can be secured to a closure eye 32 while simultaneously protecting the closure eye 32 and portion of a bolt 36 extending therethrough from tampering. It is also preferred that the housing 34 protect the entire bolt 36 that extends through the closure eye 32 when the lock assembly 30:1-30:6 is detachably secured to the closure eye.

It is preferred that the lock assembly 30:1-30:5 and its individual components are formed of high strength, durable, impact resistant material, such as hardened steel. Those of ordinary skill in the art will appreciate from this disclosure that any other suitable metals, steels, alloys, or the like can be used to form the lock assembly 30:1-30:6 without departing from the scope of the present invention.

Many of the features of the lock assemblies 30:1-30:6 of the present invention are similar and operate in a generally similar fashion. For simplicity, the first preferred lock assembly 30:1 be described and, thereafter, only the differences between the first preferred lock assembly 30:1 and the remaining preferred lock assemblies 30:2-30:5 will be discussed. Accordingly, it is understood that those features discussed in connection with any one of the embodiments of the lock assemblies 30:1-30:6 will operate generally the same in the remaining embodiments unless otherwise described.

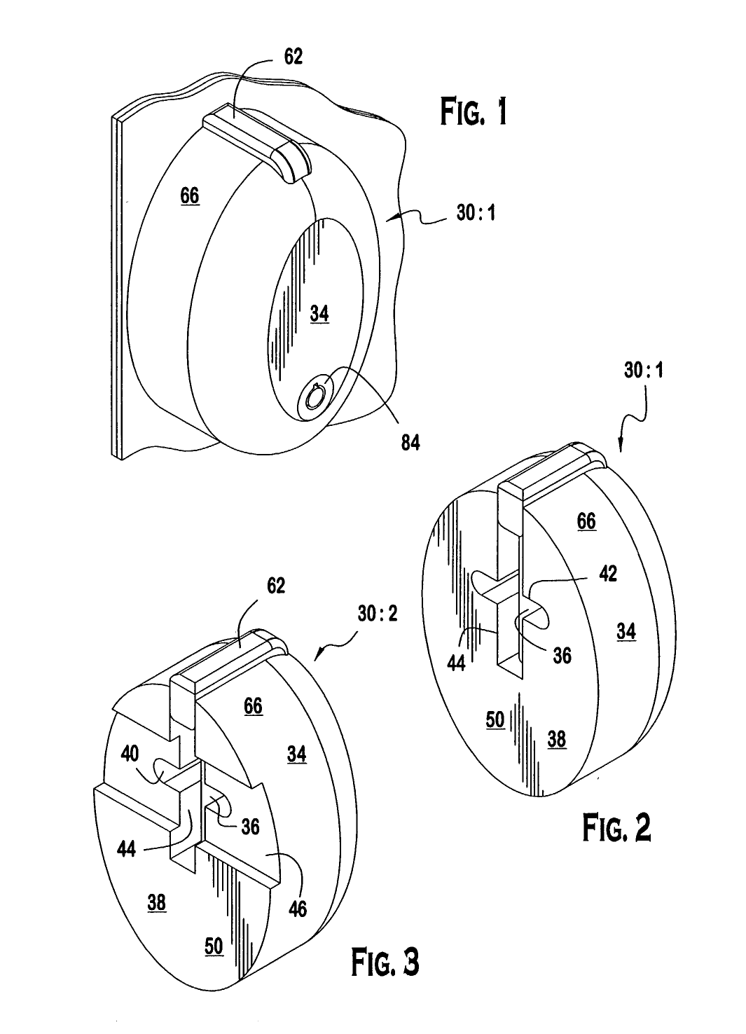

Referring to FIGS. 1 and 2, the first preferred embodiment of a lock assembly 30:1 adapted to engage the closure eye 32 includes a housing 34 having a mating surface 38. The housing is preferably dome shaped and is similar to the shape of a tortoise shell. The mating surface 38 defines a recess 40 therein. The recess 40 is adapted to receive the closure eye 32. The recess 40 preferably has a shape similar to that of an addition symbol (“+”) with a lateral slot 42 configured to receive the closure eye 32. The recess 40 preferably includes a vertical slot 44 through which the bolt 36 can pass (further described below). Those of ordinary skill in the art will appreciate from this disclosure that the particular shape of the recess 40 can be varied without departing from the scope of the present invention.

Referring to FIGS. 3-11, a second preferred embodiment of the lock assembly 30:2 is shown. The lock assembly 30:2 preferably, but not necessarily, includes a mating surface 38 that includes a complementary groove 46. The complementary groove 46 is preferably adapted to receive a hasp faceplate 48 (shown in FIG. 6). The complementary groove 46 preferably receives the hasp faceplate 48 such that the remaining portion 50 of the mating surface 38 is adapted to abut a support surface 52 on which the hasp faceplate 48 and the closure eye 32 are mounted. Those of ordinary skill in the art will appreciate from this disclosure that the lock assemblies 30:1-30:6 of the present invention can be used with any device having a lock receiving loop (i.e., with any device having a closure eye type of structure) 32. Accordingly, the complementary groove 46 can vary depending on the particular device incorporating the closure eye 32 without departing from the scope of the present invention. Additionally, the housing 34 can be configured to completely cover the hasp faceplate 48 or similar device having a closure eye 32 without departing from the scope of the present invention. Thus, regardless of the relative size of the lock assembly 30:1-30:6 relative to the hasp faceplate 48, it is preferred that the housing 34 is adapted to cover the closure eye 32 and a portion of the hasp faceplate 48 when the lock assembly 30:1-30:5 is secured to the closure 32.

While the closure eye 32 is shown as being a generally semicircular loop, those of ordinary skill in art will appreciate from this disclosure that the shape of the closure eye 32 can vary without departing from the scope of the present invention. Additionally, the cross-sectional shape of the closure eye 32 can vary without departing from the scope of the present invention.

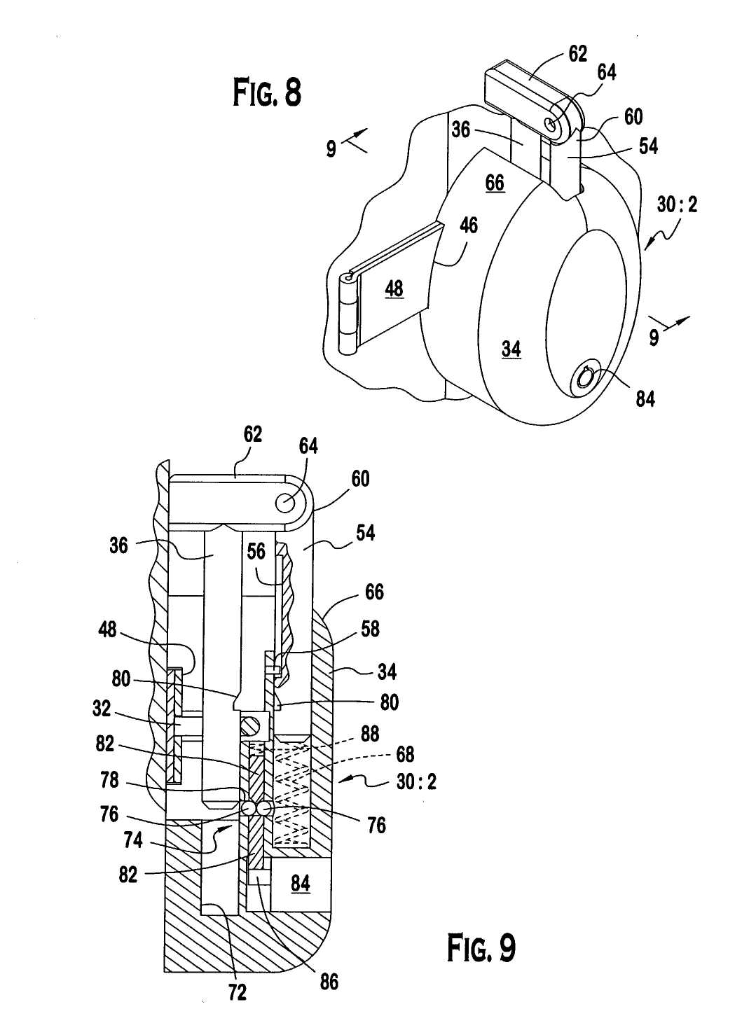

As best shown in FIGS. 9 and 11, a piston 54 is slideably positioned in the housing 34 for movement between a first piston position (shown in FIG. 11), in which the piston 54 is substantially positioned inside of the housing 34, and a second piston position (shown in FIG. 9) in which a portion of the piston 54 extends from the housing 34. Those of ordinary skill in art will appreciate that an upper end of the piston 54 may protrude from the top of the housing 34 while the piston 54 is still substantially positioned inside of the housing 34. It is preferred that the piston 54 include a generally vertical longitudinal groove 56 that limits the vertical adjustability of the piston 54. A piston guide 58 is preferably engaged with the longitudinal groove 56 to prevent the piston 54 from being withdrawn from the housing 34. While the piston 54 is preferably generally cylindrical in shape, those of ordinary skill in the art will appreciate from this disclosure that the shape of the piston 54 can vary without departing from the scope of the present invention. The piston preferably includes a piston end 60 located at an upper end of the piston 54.

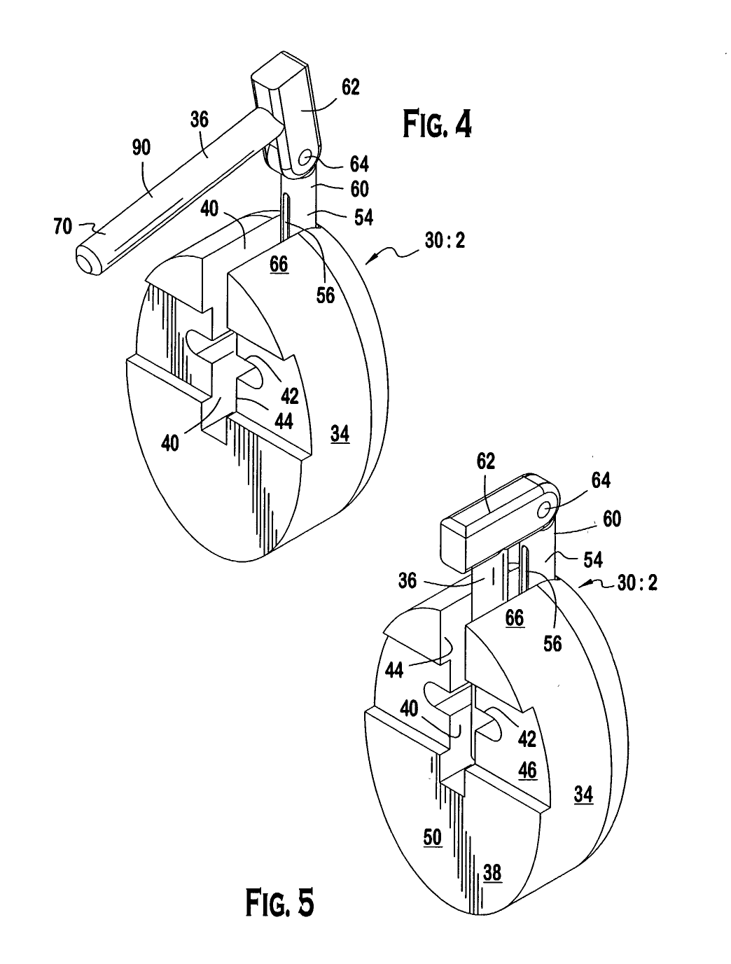

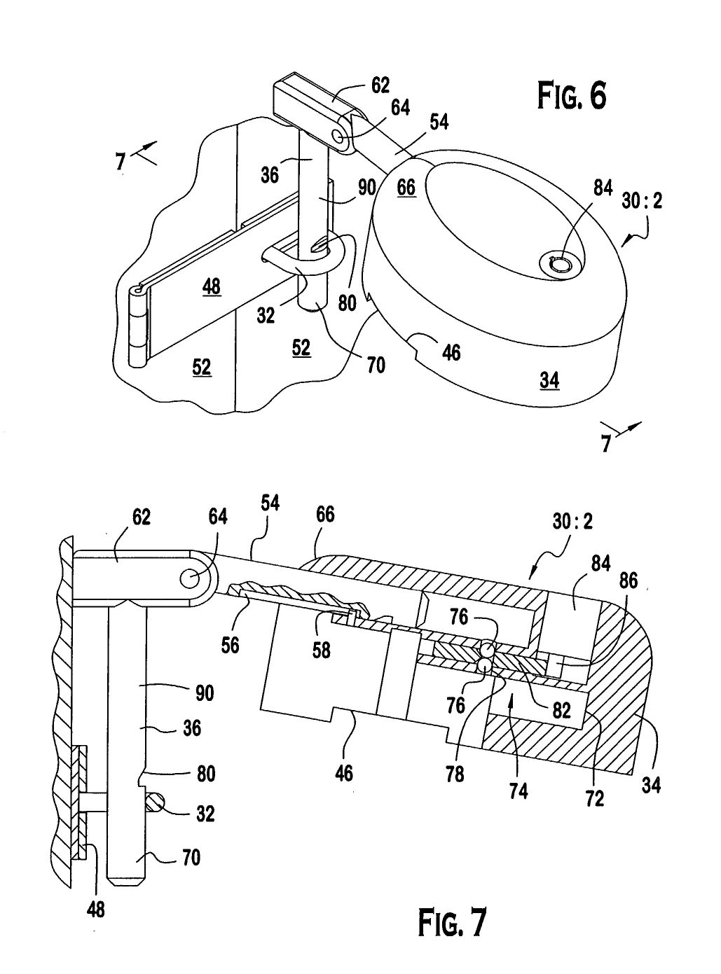

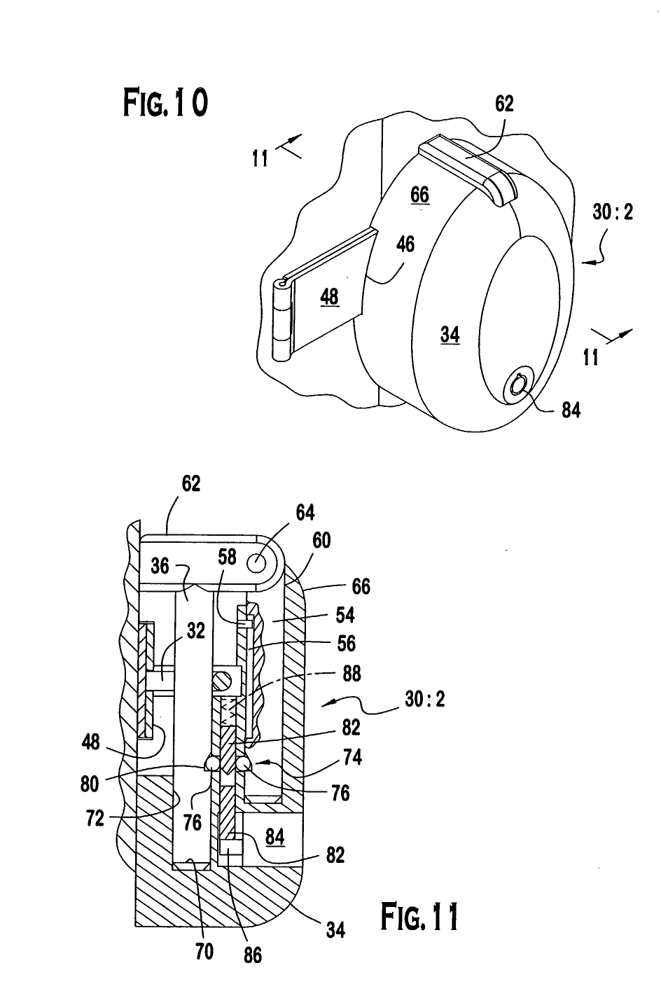

Referring to FIGS. 4 and 5, the lock assembly 30:1, 30:2 preferably includes a pivot member 62. The pivot member 62 is preferably pivotably attached to the upper piston end 60 via a pin 64. The bolt 36 is preferably positioned on the pivot member 62. The bolt 36 preferably extends generally downwardly from a mid-portion of a bottom surface of the pivot member 62. It is also preferred that the recess 40 extend along a top portion of the housing 34 to allow the piston 54, the pivot member 62, and the bolt 36 to pass therethrough. It is preferable, but not necessary, that the pivot member 62 is recessed within the housing 34 to be generally flush with an outer surface 66 of the housing 34 while the piston 54 is in the first piston position as shown in FIG. 10.

Referring to FIG. 9, it is preferred that an elastic member 68 (shown in dashed lines in FIG. 9) is disposed within the housing 34 to bias the piston 54 toward the second piston position. This results in the piston 54 being biased generally outwardly from the housing 34.

Referring again to FIGS. 4 and 5, the bolt 36 is rotatably moveable about the piston end 60 while the piston 54 is in the second (i.e. extended piston) position for movement from a first bolt position (shown in FIG. 4), in which the bolt 36 is located outside of the housing 34, through the recess 40 into a second bolt position (shown in FIG. 5) in which at least a portion of the bolt 36 is inside the housing 34. Referring to FIG. 6, a user can insert a bolt end 70 through the closure eye 32 while the bolt 36 is in the first bolt position. Then, a user rotates the lock assembly 30:1, 30:2 generally downwardly such that the housing 34 covers the bolt 36 and the closure eye 32 as shown in FIG. 8. Referring to FIG. 11, when the bolt 36 is substantially in the second bolt position and the piston 54 is moved into the first piston position, the bolt 36 moves into a third bolt position (shown in FIG. 11), in which the bolt 36 is substantially within the housing. Those of ordinary skill in the art will appreciate from this disclosure that an upper portion of the bolt 36 may protrude slightly from the top side of the housing 34 while the bolt 36 is still substantially within the housing 34. The bolt 36 is adapted to be positioned within the closure eye 32 at least while in the third bolt position to secure the lock assembly 30:1-30:2 to the closure eye 32.

Referring still to FIG. 11, the lock assembly 30:1-30:2 preferably includes a receiving tube 72. The receiving tube is generally vertically aligned within the housing 34. It is preferred that the receiving tube 72 is integrally formed with the housing 34, but those of ordinary skill in the art will appreciate from this disclosure that the receiving tube 72 may be a separate component attached to the housing 34 without departing from the scope of the present invention. The receiving tube 72 receives the bolt end 70 that passed through the closure eye 32 when the bolt 36 is in the third bolt position. It is preferred that the receiving tube 72 is generally complementary in shape to the bolt 36.

Referring to FIGS. 9 and 11, a locking mechanism 74 is adapted to detachably secure the lock assembly 30:1, 30:2 to the closure eye 32. It is preferred that the locking mechanism 74 is a double ball bearing lock mechanism that positively engages the piston 54 and the bolt 36 when the bolt 36 is in the third bolt position such that the bolt end 70 located in the receiving tube 72 is secured therein.

The locking mechanism 74 preferably includes two ball bearings 76 that are moveably positioned within a horizontal chamber 78. It is preferred that the horizontal chamber 78 is shaped to restrict the outward movement of the ball bearings 76 to prevent the ball bearings 76 from being ejected from the horizontal chamber 78. Despite the restraining of the ball bearings 76 from being ejected from the horizontal chamber 78, the ball bearings 76 can protrude outwardly therefrom as shown in FIG. 11 to engage recesses 80 in the piston 54 and the bolt 36. The positioning of the ball bearings is determined by a lock member 82.

The lock member 82 is shown in cross-section in FIGS. 9 and 11 with a portion of the lock member 82 being generally positioned above the ball bearings 76 with a generally triangular lower end and another portion of the lock member 82 being generally positioned below the ball bearings 76. While a connecting member is not shown between the upper and lower portions of the lock member 82, it is preferred that the upper and lower portions of the lock member 82 are attached. The position of the lock member 82 is controlled by a tumbler mechanism 84. At least one lock finger 86 preferably extends from the tumbler mechanism 84 to drive the lock member 82.

It is preferred that a second elastic member 88 (shown in phantom lines in FIGS. 9 and 11) biases the lock member 82 generally downwardly. This results in the lock assembly 30:1, 30:2 being autolocking when a user depresses the pivot member 62 generally downwardly to move the bolt 36 into the third bolt position and to move the piston 54 into the first piston position.

To disengage the double ball bearing locking mechanism from the bolt 36 and the piston 54, a user operates the tumbler mechanism 84 to move the locking finger 86 generally upwardly to allow the ball bearings 76 to move generally inwardly into the horizontal chamber 78 and disengage from the bolt 36 and the piston 54. When the ball bearings 76 disengage from the recesses 80 in the bolt 36 and the piston 54, it is preferable that the elastic member 68 drive the piston 54 generally upwardly into the second piston position. This results in the pivot member 62 automatically popping up when a user manipulates the tumbler mechanism 84 to disengage the double ball bearing locking mechanism 74 from the bolt 36 and the piston 54. This further simplifies the removal of lock assemblies 30:1, 30:2 from the closure eye 32. While a preferred locking mechanism 74 has been described above, those of ordinary skill in the art will appreciate from this disclosure that any suitable known locking mechanism can be used with the lock assemblies 30:1-30:6 without departing from the scope of the present invention.

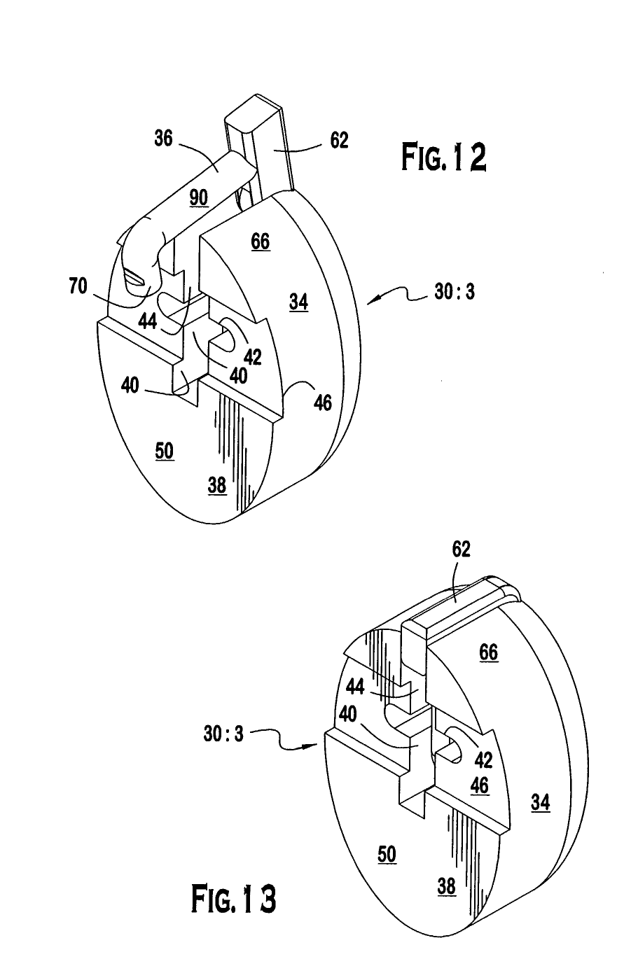

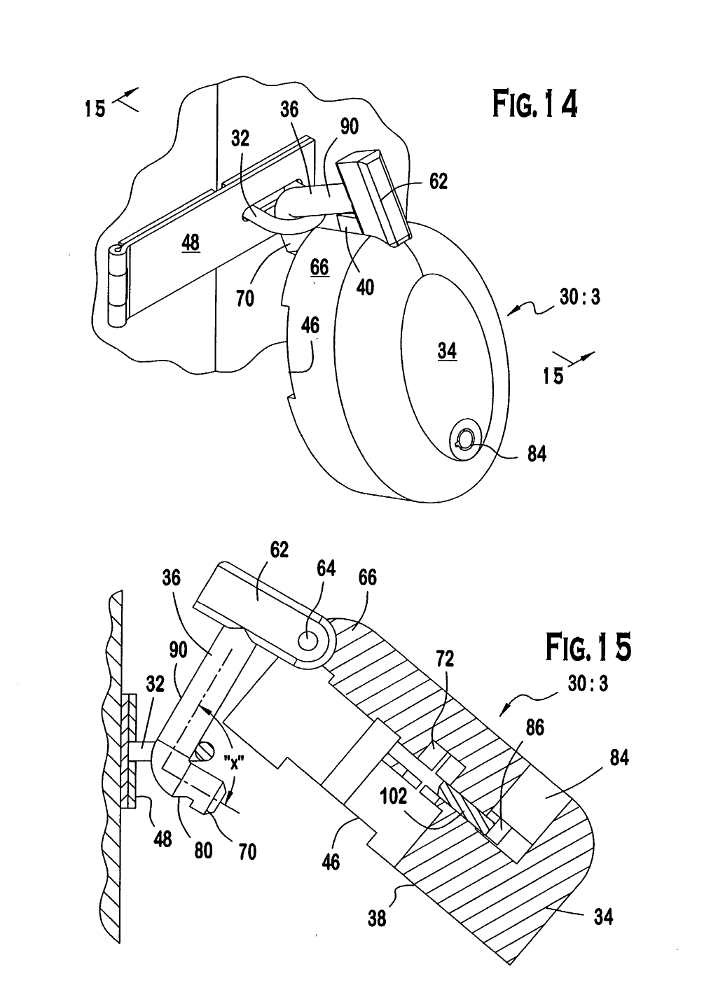

Referring to FIGS. 12-17, a third embodiment of a lock assembly 30:3 according to the present invention is shown. The bolt 36 is rotatably moveable about the housing 34. It is preferred that the bolt 36 include an elongated bolt segment 90 and a bolt end 70 that is positioned at an angle (the angle is denoted “X” in FIG. 15) relative to the elongated bolt segment 90. It is preferred that the bolt end 70 is generally perpendicular to the elongated bolt segment 90. Those of ordinary skill in the art will appreciate from this disclosure that the bolt end 70 can be askew from perpendicular by up to approximately twenty (20) degrees while still being generally perpendicular to the elongated bolt segment 90.

Referring to FIG. 21, the bolt 36 of the fifth preferred embodiment of the lock assembly 30:5 according to the present invention preferably includes a crossbar 92 positioned on second bolt end 94. The crossbar 92 is rotatably secured in the housing 34. One method of rotatably securing the crossbar 92 within the housing 34 is to insert the crossbar 92 into a receptacle 96 and to secure the crossbar 92 therein via blocks 98 that are secured thereover. The blocks 98 can be secured in position via welding, adhesive, or any other known suitable means for securing the blocks 98 over the receptacle to secure the crossbar 92 of the bolt 36 within the housing 34.

Referring to FIG. 26, the sixth preferred embodiment of the lock assembly 30:6 has an elongated bolt segment 90 that is separate from the crossbar and can be bent therearound to allow the free rotation of the bolt 36 about a crossbar which would serve as a pivot pin 64. Thus, the second bolt end 94 can be curved about a shaft (i.e., a crossbar) or an equivalent shaft located within the housing 34 to allow the bolt 36 to rotate relative to the pin 64.

Referring to FIGS. 15 and 17, it is preferred that the receiving tube 72 of the third preferred embodiment of the lock assembly 30:3 be positioned within the housing 34 so that the receiving tube 72 receives the bolt end 70 when the bolt 70 is substantially in the second bolt position (shown in FIG. 17). When the bolt end 70 is angled relative to the elongated bolt segment 90, the location of the receiving tube 72 within the housing 34 is adjusted accordingly. Specifically, the third and forth preferred embodiments of the lock assembly 30:3, 30:4 preferably incorporate a receiving tube 72 that is located generally perpendicularly to the elongated bolt segment 90 while the bolt 36 is in the second bolt position. Referring to FIG. 18, the forth embodiment of a lock assembly 30:4 of the present invention preferably includes an elastic member 100 that is disposed within the receiving tube 72 to bias the bolt 36 toward the first bolt position (shown in FIG. 12).

Referring to FIGS. 17 and 18, it is preferred that the third and fourth preferred embodiments of the lock 30:3, 30:4 include a locking mechanism 74 that positively engages the bolt end 70 when the bolt is in the second bolt position such that the bolt end 70 located in the receiving tube 72 is secured therein. The locking mechanism 74 preferably includes a tumbler mechanism 84 capable of driving a lock member 102 into engagement with a recess 104 in the angled bolt end 70. It is preferred that the lock member 102 is biased generally upwardly so that the locking mechanism 74 is autolocking when the bolt 36 is moved into the second bolt position.

Referring again to FIGS. 12-17, it is preferred that the bolt 36 is moveable from a first bolt position (shown in FIG. 12) in which the bolt 36 is located outside of the housing 34, through the recess 40 into a second bolt position (shown in FIGS. 13 and 17), in which at least a portion of the bolt 36 is inside the housing 34. The bolt 36 is adapted to be positioned within the closure eye 32 at least while the bolt 36 is substantially in the second bolt position to secure the lock assembly 30:3 to the closure eye 32.

Referring to FIGS. 1 and 2, the first preferred embodiment of the lock assembly 30:1 has a mating surface 38 with a recess 40 that is adapted to receive the closure eye 32 and the to allow the bolt 36, the closure eye 32, and the pivot member 62 to pass at least partially therethrough. FIG. 1 illustrates the lock assembly 30:1 installed over a closure eye 32.

FIGS. 3-11 illustrate the second preferred embodiment of the lock assembly 30:2 and illustrate a housing 34 having a mating surface 38 with a complementary groove 46 therein. FIGS. 4 and 5 show the bolt 36 in the first and second bolt positions, respectively. FIG. 11 illustrates the bolt 36 in the third bolt position and illustrates the piston 54 in the first piston position. FIG. 9 illustrates the piston 54 in the second piston position.

FIGS. 12-17 illustrate the third preferred embodiment of the locking mechanism which incorporates a bolt 36 having an angled bolt end 70 that is preferably pivotably attached directly to the housing 34. FIG. 18 illustrates a fourth preferred embodiment of the lock assembly 30:4 which incorporates a biasing elastic member 100 to bias the bolt 36 toward the first bolt position.

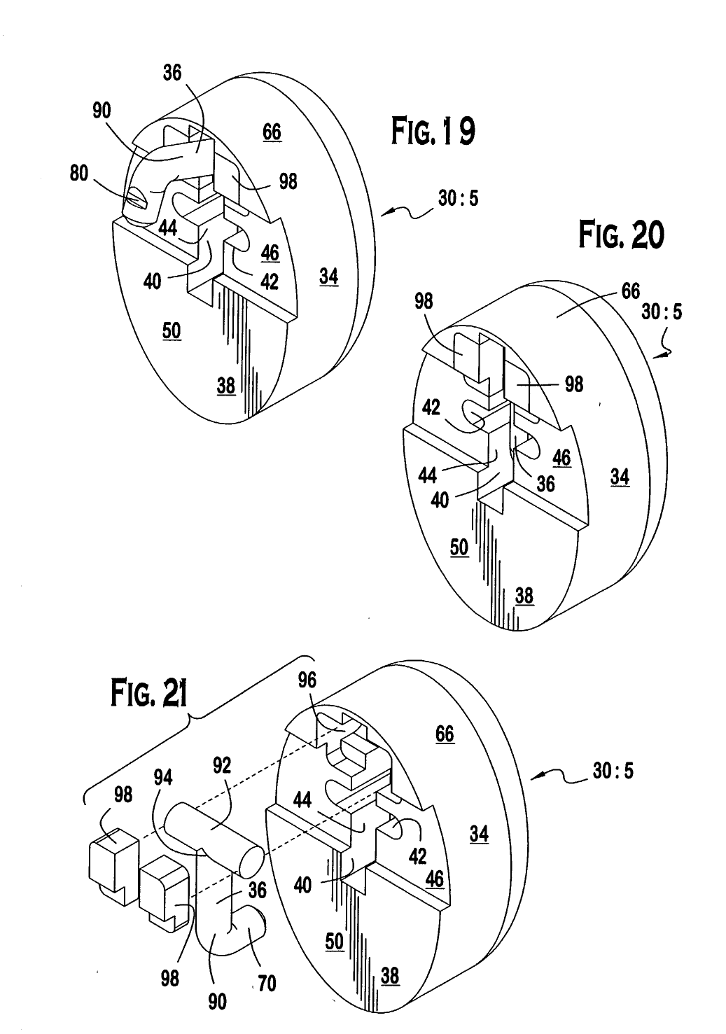

FIGS. 19-25 illustrate the fifth preferred embodiment of the lock assembly 30:5 bolt 36 having a crossbar 92 that allows the bolt 36 to rotatably secured within a receptacle 96 in the housing 34. FIG. 26 illustrates the sixth preferred embodiment of the lock assembly 30:6 which has a bolt end that is wrapped around a pin 64.

Referring to FIGS. 3-11, one embodiment of the present invention operates as follows. A user operates the tumbler 84 to slide the lock 82 generally upwardly which allows the ball bearings 76 to disengage from the piston 54 and the bolt 36. This results in the elastic member 68 biasing the piston 54 into the second piston position (shown in FIGS. 4-9). Once the piston 54 is in the second piston position, a user rotates the pivot member 62 generally clockwise as viewed in FIG. 4 to move the bolt 36 into the first bolt position (shown in FIG. 4). Then, the user inserts the bolt 36 through the closure eye 32 of a locking device as shown in FIGS. 6 and 7. Then, the user rotates the housing 34 generally downwardly to cover the closure 32 and the bolt 36 as shown in FIGS. 8 and 9. Then, to secure the lock 30:2 to the closure eye 32, a user downwardly presses the pivot member 62 causing the piston 54 to return to the first piston position and causing the bolt 36 to move into the third bolt position. Once the piston 54 is in the first piston and the bolt 36 in the third bolt position, the biasing spring 88 drives the lock member 82 generally downwardly forcing the ball bearings 76 to engage the recesses 80 in the piston 54 and the bolt 36. Once the ball bearings 76 are positioned partially in the recesses 80 and partially in the horizontal chamber 78, the lock 30:2 is secured in position over the closure eye and at least a portion, if not all, of the hasp faceplate 48. It is preferred, but not necessary, that the pivot member 62 is flushly aligned with the outer surface of the housing 34. Thus, the tamper resistant lock assembly 30:1-30:6 secures the hasp assembly while simultaneously protecting the closure eye 32 and the bolt 36 from being cut by an authorized user. This dramatically increases the security provided by the lock assembly 30:1-30:6.

While various shapes, configurations, lock positions, and tamper resistant features have been described above and shown in the drawings for the various embodiments of the present invention, those of ordinary skill in the art will appreciate from this disclosure that any combination of the above features, bolts, housing, pivot connections, or the like can be used without departing from the scope of the present invention. Accordingly, it is recognized by those skilled in the art that changes may be made to the above described embodiments of the invention without departing from the broad inventive concept thereof. It is understood, therefore, that this invention is not limited to the particular embodiments disclosed, but is intended to cover all modifications which are in within the spirit and scope of the invention as defined by the appended claims and/or shown in the attached drawings.

What is claimed is:

1. A lock assembly adapted to engage a closure eye, comprising:
a housing having a mating surface, the mating surface defining a recess therein, the recess being adapted to receive the closure eye;
a piston slidably positioned in the housing for movement between a first piston position, in which the piston is substantially positioned inside the housing, and a second piston position, in which a portion of the piston extends from the housing, the piston having a piston end;
a bolt rotatably moveable about the piston end while the piston is in the second piston position for movement from a first bolt position, in which the bolt is located outside of the housing, through the recess into a second bolt position, in which at least a portion of the bolt is inside the housing, when the bolt is substantially in the second bolt position and the piston is moved into the first piston position the bolt moves into a third bolt position, in which the bolt is substantially within the housing, the bolt being adapted to be positioned within the closure eye at least while in the third bolt position to secure the lock assembly to the closure eye; and
a locking mechanism adapted to detachably secure the lock assembly to the closure eye.

2. The lock assembly of claim 1, further comprising a receiving tube positioned within the housing, the receiving tube receives a bolt end that passed through the closure eye when the bolt is in the third bolt position.

3. The lock assembly of claim 1, further comprising a pivot member pivotally attached to the piston end, the bolt being positioned on the pivot member.

4. The lock assembly of claim 2, wherein the locking mechanism positively engages the piston and the bolt when the bolt is in the third bolt position such that the bolt end located in the receiving tube is secured therein.

5. The lock assembly of claim 4, wherein the locking mechanism is a double ball bearing lock mechanism.

6. The lock assembly of claim 1, further comprising an elastic member disposed within the housing to bias the piston toward the second piston position.

7. The lock assembly of claim 1, wherein the mating surface includes a complementary groove adapted to receive a hasp faceplate such that a remaining portion of the mating surface is adapted to abut a support surface on which the hasp faceplate and closure eye are mounted.

8. The lock assembly of claim 3, wherein the pivot member is recessed within the housing to be generally flush with an outer surface of the housing while the piston is in the first piston position.

9. The lock assembly of claim 1, wherein the housing is adapted to cover the closure eye and a portion of a hasp faceplate when the lock assembly is secured to the closure eye.

10. A lock assembly adapted to engage a closure eye, comprising:
a housing having a mating surface, the mating surface defining a recess therein, the recess being adapted to receive the closure eye;
a bolt rotatably moveable about the housing and moveable from a first bolt position, in which the bolt is located outside of the housing, through the recess into a second bolt position, in which at least a portion of the bolt is inside the housing, the bolt being adapted to be positioned within the closure eye at least while the bolt is substantially in the second bolt position to secure the lock assembly to the closure eye; and
a locking mechanism adapted to detachably secure the lock assembly to the closure eye.

11. The lock assembly of claim 10, wherein the bolt includes an elongated bolt segment and a bolt end that is positioned at an angle relative to the elongated bolt segment.

12. The lock assembly of claim 11, wherein the bolt end is generally perpendicular to the elongated bolt segment.

13. The lock assembly of claim 11, further comprising a receiving tube positioned within the housing, the receiving tube receives the bolt end when the bolt is substantially in the second bolt position.

14. The lock assembly of claim 11, further comprising a pivot member pivotally attached to the housing, the bolt being positioned on the pivot member.

15. The lock assembly of claim 11, wherein the bolt includes a crossbar positioned on a second bolt end, the crossbar being rotatably secured in the housing.

16. The lock assembly of claim 11, wherein a second bolt end is curved about a shaft located within the housing to allow the bolt to rotate relative to the shaft.

17. The lock assembly of claim 13, wherein the locking mechanism positively engages the bolt end when the bolt is in the second bolt position such that the bolt end located in the receiving tube is secured therein.

18. The lock assembly of claim 13, further comprising an elastic member disposed within the receiving tube to bias the bolt toward the first bolt position.

19. The lock assembly of claim 10, wherein the mating surface includes a complementary groove adapted to receive a hasp faceplate such that a remaining portion of the mating surface is adapted to abut a support surface on which the hasp faceplate and closure eye are mounted.

20. The lock assembly of claim 14, wherein the pivot member is recessed within the housing to be generally flush with an outer surface of the housing while the piston is in the first piston position.

21. The lock assembly of claim 10, wherein the housing is adapted to cover the closure eye and a portion of a hasp faceplate when the lock assembly is secured to the closure eye.
